(19) United States
(12) Patent Application Publication
(10) Pub. No.: US 2026/0289954 A1
(43) Pub. Date: Sep. 24, 2026

(54) METHOD AND SYSTEM FOR TRAINING A CAR PARTS DETECTOR USING CAMERA RGB DATA WITH DEPTH INFORMATION

(71) Applicant: Toyota Research Institute, Inc., Los Altos, CA (US)

(72) Inventors: Kiyomasa Akaike, San Jose, CA (US); Mark Edward Tjersland, Mountain View, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/083,943

(22) Filed: Mar. 19, 2025

(51) Int. Cl. G06V 10/70; G06T 7/55; G06T 11/00

(52) U.S. Cl. CPC G06V 10/70; G06T 7/55; G06T 11/00; G06V 2201/08

(57) ABSTRACT

A method may include generating synthetic images of virtual car parts in virtual containers at selected positions and having selected orientations, generating a left image and a right image associated with each synthetic image, determining depth information for pixels of the synthetic images based on the left image and the right image associated with each synthetic image, and training a machine learning model to identify a car part and a container in a received image using training data comprising the depth information and only one of the left image or the right image associated with each synthetic image.

### TECHNICAL FIELD

The present specification relates to training a car parts detector, and more particularly to a method and system for training a car parts detector using camera RGB data with depth information.

### BACKGROUND

A robot may be used to pick car parts from a container. In particular, the robot may capture an image of an open container and identify car parts within the container based on the image. The robot may then pick one or more of the identified car parts using a robot arm or other physical device.

However, current technology cannot localize car parts in images accurately. Identifying specific car parts in images typically requires extensive training of a model, and retraining of the model whenever car parts change (e.g., due to production updates). Moreover, obtaining real data for training a car parts detector presents significant challenges due to the presence of confidential information, such as proprietary manufacturing methods and intricate car part designs. Additionally, it may not be practical to modify lighting conditions or introduce unconventional objects in factories to gather high-quality datasets. Such issues may incur substantial costs, which may hinder factory automation. As such, there is a need for an improved car parts detector.

### SUMMARY

In one embodiment, a method may include generating synthetic images of virtual car parts in virtual containers at selected positions and having selected orientations, generating a left image and a right image associated with each synthetic image, determining depth information for pixels of the synthetic images based on the left image and the right image associated with each synthetic image, and training a machine learning model to identify a car part and a container in a received image using training data comprising the depth information and only one of the left image or the right image associated with each synthetic image.

In another embodiment, a computing device may include one or more processors configured to generate synthetic images of virtual car parts in virtual containers at selected positions and having selected orientations, generate a left image and a right image associated with each synthetic image, determine depth information for pixels of the synthetic images based on the left image and the right image associated with each synthetic image, and train a machine learning model to identify a car part and a container in a received image using training data comprising the depth information and only one of the left image or the right image associated with each synthetic image.

In another embodiment, a non-transitory computer readable storage medium may include a memory storing a program. When executed by a processor, the program may cause the processor to generate synthetic images of virtual car parts in virtual containers at selected positions and having selected orientations, generate a left image and a right image associated with each synthetic image, determine depth information for pixels of the synthetic images based on the left image and the right image associated with each synthetic image, and train a machine learning model to identify a car part and a container in a received image using training data comprising the depth information and only one of the left image or the right image associated with each synthetic image.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example computing device for training a car parts detector on RGB data with two labels, according to one or more embodiments shown and described herein;

FIG. 2 schematically depicts a plurality of memory modules of the computing device of FIG. 1, according to one or more embodiments shown and described herein;

FIG. 3A depicts an example image of virtual car parts in a virtual container, according to one or more embodiments shown and described herein;

FIG. 3B depicts another example image of virtual car parts in a virtual container, according to one or more embodiments shown and described herein;

FIG. 4A depicts an example image of virtual car parts in a virtual container, according to one or more embodiments shown and described herein;

FIG. 4B depicts a depth map of the image of FIG. 4A, according to one or more embodiments shown and described herein;

FIG. 4C depicts the example image of FIG. 4A with bounding boxes around the virtual car parts and the virtual containers, according to one or more embodiments shown and described herein;

FIG. 5A depicts a plot of example results of training a machine learning model, according to one or more embodiments shown and described herein;

FIG. 5B depicts another plot of example results of training a machine learning model, according to one or more embodiments shown and described herein;

FIG. 6 depicts an image that may be output by the computing device of FIG. 1, according to one or more embodiments shown and described herein; and

FIG. 7 depicts a flowchart of an example method for operating the computing device of FIG. 1, according to one or more embodiments shown and described herein.

### DETAILED DESCRIPTION

The embodiments disclosed herein describe a method and system for training a car parts detector using camera RGB data from only one of a left camera and right camera, with depth information. In particular, virtual car parts may be randomly selected from a database to be used as training data for a machine learning model. The database may include images of real car parts and/or computer generated images of car parts. A synthetic image may be generated that includes the selected virtual car parts placed in a virtual container. A left and right image associated with the synthetic image may then be generated. Depth information for the pixels of the synthetic image may be generated based on the left and right image.

Bounding boxes may be placed around the car parts and the container in the images. The only one of the left image and the right image, and the depth information may be used as a training example to train a machine learning model to identify a car part and a container in a received image.

A large number of training examples may be generated in such a manner with different virtual car parts and different virtual containers. The training examples may also include virtual car parts with different orientations, and the images may include different backgrounds. All of the training examples may be used as training data to train the machine learning model to receive an image including one or more car parts in a container and classify the container and the car parts in the image (e.g., by drawing different bounding boxes around the car parts and the container). A robot may then use the trained machine learning model to identify real car parts in an actual container and pick out the identified car parts using a robotic arm or other mechanism.

By using only one of the left image and the right image associated with each synthetic image, rather than the left image and a right image, the training of the machine learning model can be done more quickly due to the smaller amount of training data used. Furthermore, using only one of the left image and the right image actually, surprisingly and unexpectedly, increases the accuracy of the trained machine learning model in identifying car parts in a container. In particular, training the machine learning model using both the left image and the right image of each synthetic image tends to result in overfitting, and hindering the performance of the machine learning model. While embodiments described herein utilize only the left image of each synthetic image as training data, in other examples, the machine learning may be trained using only the right image of each synthetic image as training data. Furthermore, while the embodiments disclosed herein are directed to training a machine learning model to detect car parts in one or more containers, in other examples, the disclosed machine learning model may be used to train a machine learning model to detect other objects in one or more containers.

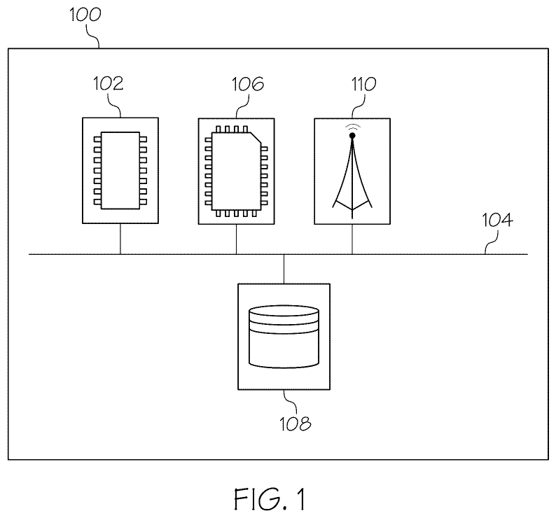

Turning now to the figures, FIG. 1 schematically depicts an example configuration of a computing device 100, according to the embodiments disclosed herein. The computing device 100 may comprise a variety of different types of devices (e.g., a local computing system, a cloud computing system, and the like). The computing device 100 may perform the operations of the embodiments disclosed herein. In the illustrated example, the computing device 100 includes one or more processors 102, a communication path 104, one or more memory modules 106, a data storage component 108, and network interface hardware 110, the details of which will be set forth in the following paragraphs.

Each of the one or more processors 102 may be any device capable of executing machine readable and executable instructions. Accordingly, each of the one or more processors 102 may be a controller, an integrated circuit, a microchip, a computer, or any other physical or cloud-based computing device. The one or more processors 102 are coupled to a communication path 104 that provides signal interconnectivity between various modules of the computing device 100. Accordingly, the communication path 104 may communicatively couple any number of processors 102 with one another, and allow the modules coupled to the communication path 104 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth®, Near Field Communication (NFC) and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

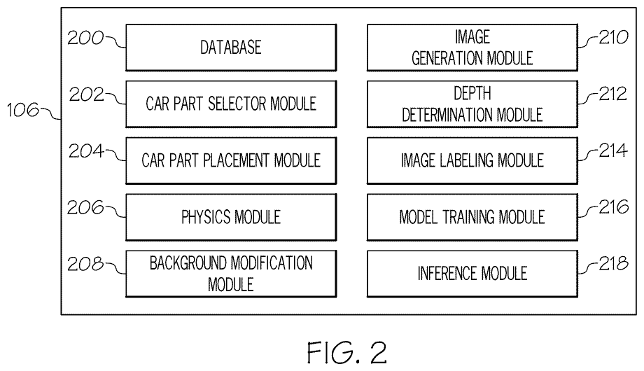

The computing device 100 includes one or more memory modules 106 coupled to the communication path 104. The one or more memory modules 106 may comprise RAM, ROM, flash memories, hard drives, or any device capable of storing machine readable and executable instructions such that the machine readable and executable instructions can be accessed by the one or more processors 102. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 106. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 106 are discussed in more detail below in connection with FIG. 2.

Referring still to FIG. 1, the example computing device 100 includes a data storage component 108. The data storage component 108 may store data used by the computing device 100. The data storage component 108 may also store other data used by the various components of the computing device 100.

Still referring to FIG. 1, the computing device 100 comprises network interface hardware 110 for communicatively coupling the computing device 100 to the external computing devices. As such, the network interface hardware 110 may send data to and/or receive data from various external computing devices. The network interface hardware 110 may comprise a wired and/or wireless connection to one or more external computing devices. In other examples, the network interface hardware 110 may be send data to and/or receive data from other computing devices.

The network interface hardware 110 can be communicatively coupled to the communication path 104 and can be any device capable of transmitting and/or receiving data via a network. Accordingly, the network interface hardware 110 can include a communication transceiver for sending and/or receiving any wired or wireless communication. For example, the network interface hardware 110 may include an antenna, a modem, LAN port, Wi-Fi card, WiMax card, mobile communications hardware, near-field communication hardware, satellite communication hardware and/or any wired or wireless hardware for communicating with external computing devices.

Referring now to FIG. 2, the one or more memory modules 106 of the computing device 100 include a database 200, a car part selector module 202, a car part placement module 204, a physics module 206, a background generation module 208, an image generation module 210, a depth determination module 212, an image labeling module 214, a model training module 216, and an inference module 218. Each of the database 200, the car part selector module 202, the car part placement module 204, the physics module 206, the background generation module 208, the image generation module 210, the depth determination module 212, the image labeling module 214, the model training module 216, and the inference module 218 may be a program module in the form of operating systems, application program modules, and other program modules stored in one or more memory modules 106. Such a program module may include, but is not limited to, routines, subroutines, programs, objects, components, data structures and the like for performing specific tasks or executing specific data types as will be described below.

The database 200 may store information about virtual car parts. In particular, the database 200 may comprise a database of virtual car parts to be used to generate training data for a car parts detector, as disclosed herein. The database 200 may also store parameters associated with a machine learning model maintained by the computing device 100, as disclosed herein.

As discussed above, a car part picking robot may utilize a machine learning model to identify car parts in a container. As such, during operation, the robot may capture an image of a container containing one or more car parts (e.g., using a camera), and input the image into a trained machine learning model. The machine learning model identify the car parts in the image, and output a new image with bounding boxes around the car parts in the image. The robot may then pick the identified car parts out of the container (e.g., using a robotic arm).

As such, a machine learning model may be trained to identify car parts in an image. However, as discussed above, using training data comprising images of real car parts may be expensive. It may be time consuming for humans to set up enough different arrangements of car parts to generate sufficient training data to train the model. Furthermore, it may be difficult and time consuming for humans to manually label each and every car part in each image. As such, in embodiments disclosed herein, synthetic data of virtual car parts is used to generate training data for a car parts selector, rather than images of actual car parts.

Accordingly, the database 200 may store a plurality of potential virtual car parts. That is, the database 200 may store parameters associated with virtual car parts. This may include a variety of properties about each such virtual car parts, such as an image of the virtual car part, a shape and size of the virtual car part, a weight of the virtual car part, material properties of the virtual car part, and the like. In some examples, the database 200 may store computer-aided-drafting (CAD) files associated with virtual car parts. As such, as disclosed in further detail below, training data may be generated by selecting virtual car parts from the database 200, and generating images of the selected virtual car parts in a virtual container (e.g., a bin or a tote). As such, in some examples, the database 200 may store data about virtual containers that the virtual car parts may be placed in. In some examples, the virtual containers may have properties matching containers that actual car parts are stored in (e.g. in a factory).

Referring back to FIG. 2, the car part selector module 202 may select one or more virtual car parts from among the potential virtual car parts stored in the database 200 to generate a synthetic image, as disclosed herein. In order to generate sufficient training data to train the machine learning model, a large number of training examples may be included with different training examples comprising a variety of different numbers and types of car parts in a variety of different configurations (e.g., in different positions and orientations). As such, the car part selector module 202 may select virtual car parts for each such training example.

In some examples, the car part selector module 202 may randomly select the number, size, and/or types of virtual car parts from the database 200. In some examples, the car part selector module 202 may only select a number of virtual car parts up to a predetermined maximum number of virtual car parts (e.g., a maximum of 10 virtual car parts), or a maximum aggregate size of virtual car parts. Setting a maximum number or maximum aggregate size of virtual car parts to select may prevent the car part selector module 202 from selecting too many car parts to fit in a virtual container.

In some examples, a user may specify the maximum number of virtual car parts that the car part selector module 202 may select. In these examples, the car part selector module 202 may first randomly select a number of virtual car parts to select (e.g., between 1 and the specified or predetermined maximum number). The car part selector module 202 may then randomly select a number of virtual car parts equal to the selected random number. In some examples, a user may specify the exact number of car parts to be selected for a particular training example. In other examples, the car part selector module 202 may select different numbers of car parts for each training example. For example, the car part selector module 202 may randomly select 1 virtual car part for a certain number of training examples, 2 virtual car parts for some number of other training examples, 3 virtual car parts for a number of other training examples, and so on, up to the maximum number of car parts to be selected. In some examples, a user may specify a range of sizes for the virtual car parts, and the car part selector module 202 may select only car parts within the specified range of sizes.

While the above examples describe the car part selector module 202 randomly selecting virtual car parts from the potential virtual car parts in the database 200, in other examples, the car part selector module 202 may select virtual car parts in a more deterministic, non-random manner. For example, the potential virtual car parts in the database 200 may be organized into categories, and for a particular training example, the car part selector module 202 may only select car parts within a single category. In other examples, the car part selector module 202 may select car parts from different categories. In some examples, the car part selector module 202 may select different combinations of car parts from the potential virtual car parts in the database 200 using some predetermined method (e.g., using Monte Carlo selection to determine the different combinations).

In some examples, the car part selector module 202 may also select a virtual container to place the selected virtual car parts in. In some examples, the car part selector module 202 may randomly select a virtual container from among potential virtual containers stored in the database 200. In some examples, the car part selector module 202 may select a single container to include in an image, while in other examples, the car part selector module 202 may include multiple containers to include in an image. In some examples, the car part selector module 202 may randomly select a number of containers to include in an image up to a predetermined or selected maximum number. In some examples, a user may specify a virtual container or containers to be used. In some examples, the car part selector module 202 may select different virtual containers (e.g., containers of different colors, shapes, and sizes) for different training examples using a predetermined selection method.

Referring still to FIG. 2, the car part placement module 204 may place the virtual car parts selected by the car part selector module 202 in the virtual container selected by the car part selector module 202, as disclosed herein. As described herein, placing a virtual car part in a virtual container means determining a position and orientation of the virtual car part in the virtual container (e.g., by using a CAD program).

In embodiments, the car part placement module 204 may randomly select initial positions and initial orientations for the virtual car parts in the virtual container selected by the car part selector module 202. However, the car part placement module 204 may select the initial positions and initial orientations for each virtual car part in a training example such that the virtual car parts do not overlap with each other, which would not be physically possible for real car parts. In one example, the car part placement module 204 may randomly select an initial position and an initial orientation for a first virtual car part in a training example. The car part placement module 204 may then randomly select an initial position and an initial orientation for a second virtual car part in the training example such that the second virtual car part does not overlap with the first virtual car part. This process may be continued for each virtual car part in a training example. By randomly selecting different virtual car parts and placing them in a variety of different positions and orientations, training data may be generated containing a wide variety of training examples, which may allow the machine learning module to be better trained.

Referring still to FIG. 2, the physics module 206 may use a physics engine to simulate natural movement of the virtual car parts placed in the virtual container until they settle at resting positions and resting orientations. As discussed above, the car part placement module 204 may place the selected virtual car parts at random positions in the virtual container with random orientations. However, this may result in virtual car parts being placed in positions that would not be possible with real car parts. For example, virtual car parts may be placed at unnatural angles or on top of each other, which would cause real car parts to fall or tip over. As such, training the machine learning model with training examples having such

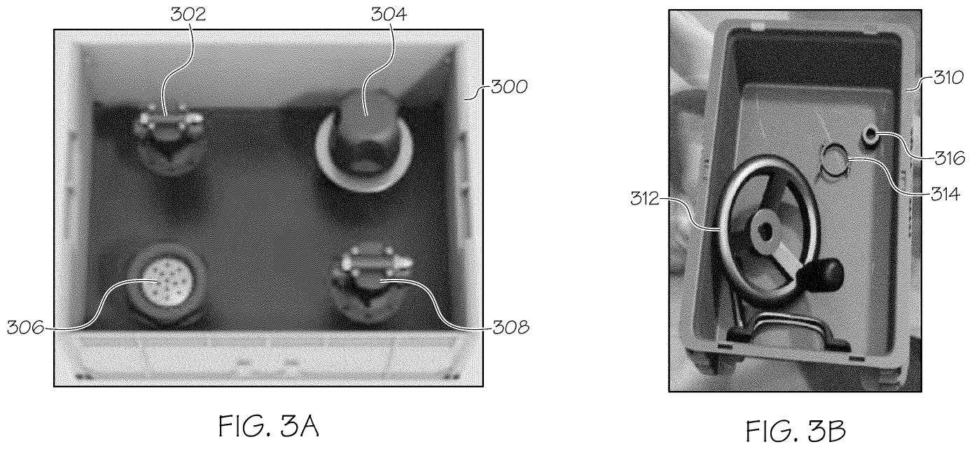

FIG. 3A shows an example image of virtual car parts 302, 304, 306, 308 that may be placed in virtual container 300 by the car part placement module 204. In the example of FIG. 3A, each virtual car part 302, 304, 306, 308 is placed at an unstable angle, such as balancing on a narrow end. If real car parts were arranged in this manner, they would tip over. As such, the image of FIG. 3A does not represent an actual possible arrangement of car parts, and as such would be a poor training example.

Accordingly, the physics module 206 may use a physics engine to simulate movement of the car parts placed by the car part placement module 204 in a virtual container, as disclosed herein. As discussed above, the database 200 stores physical properties of the potential virtual car parts (e.g., size, shape, weight, materials). As such, after the selected virtual car parts are placed in the virtual container, the physics module 206 may use a physics engine to determine how the virtual car parts would naturally move when placed in the initial positions with initial orientations.

For example, the physics engine may apply gravity to the virtual car parts and account for collisions between the virtual car parts and/or with the virtual container to allow the virtual car parts to settle at stable locations and orientations. Once the virtual car parts stop moving after being acted upon by the physics engine, their final positions and orientations, which may be referred to herein as resting positions and resting orientations, may be used for a training example. As such, the training examples used to train the machine learning model may comprise more realistic scenarios of how real car parts may be arranged in real life scenarios. FIG. 3B shows an image of virtual container 310 containing virtual car parts 312, 314, 316. In the example of FIG. 3B, the physics module 206 has been used to allow the virtual car parts 312, 314, 316 to settle at resting positions resting orientations. As such, the image of FIG. 3B shows car parts in an arrangement that could actually exist in real life.

Referring back to FIG. 2, the background generation module 208 may generate or modify a background of an image to be used in a training example. In a real life situation in which a robot is picking car parts from an actual container, there may be a background image around the container holding the car parts. If this is not accounted for in training the machine learning module, the robot may be confused and unable to distinguish between the car parts and items in the background. As such, the background generation module 208 may generate or modify a background of training example images in order to improve the robustness of the training data and the quality of the training of the machine learning model. In some examples, the database 200 may contain a number of predetermined background images. As such, in embodiments the background generation module 208 may apply one of these predetermined background images to a training example image.

Still referring to FIG. 2, the image generation module 210 may generate a synthetic RGB image of one or more containers each containing one or more car parts. In particular, the image generation module 210 may generate a synthetic image containing the containers and car parts selected by the car part selector module 202. The car parts may be placed in the container or containers at the positions and orientations determined by the car part placement module 204 and the physics module 206, as discussed above. The image generation module 210 may also generate a background for the image as determined by the background generation module 208. As such, the image generated by the image generation module 210 may include one or more containers each containing one or more car parts along with a background, which may include one or more distractors.

After the image generation module 210 generates a synthetic image of one or more containers containing one or more car parts, the image generation module 210 may generate a left and right image associated with the generated synthetic image. In particular, the image generation module 210 may generate two images of a scene in the synthetic image from two perspectives that may be captured by two cameras at different locations (e.g., a left camera and a right camera). The left image captured by the left camera and the right image captured by the right image may be used to determine depth information for the scene, as discussed in further detail below.

Referring still to FIG. 2, the depth determination module 212 may determine depth values for the pixels of the synthetic image generated by the image generation module 210, as disclosed herein. As disclosed in further detail below, after a plurality of images are generated by the image generation module 210, using the techniques discussed above, a machine learning model may be trained using the plurality of labeled images as training data to identify car parts and containers in the training data images. However, in embodiments disclosed herein, in order to improve the accuracy of the machine learning model, the training data may also include depth information. As such, in embodiments disclosed herein, the depth determination module 212 may determine such depth information (e.g., as a depth map).

In embodiments, the depth determination module 212 may determine a depth map for the scene based on the left image and the right image of a scene generated by the image generation module 210, as discussed above. For example, the left image and the right image may be input to a neural network that outputs a depth map based on the input images. In other examples, other methods may be used to determine the depth information.

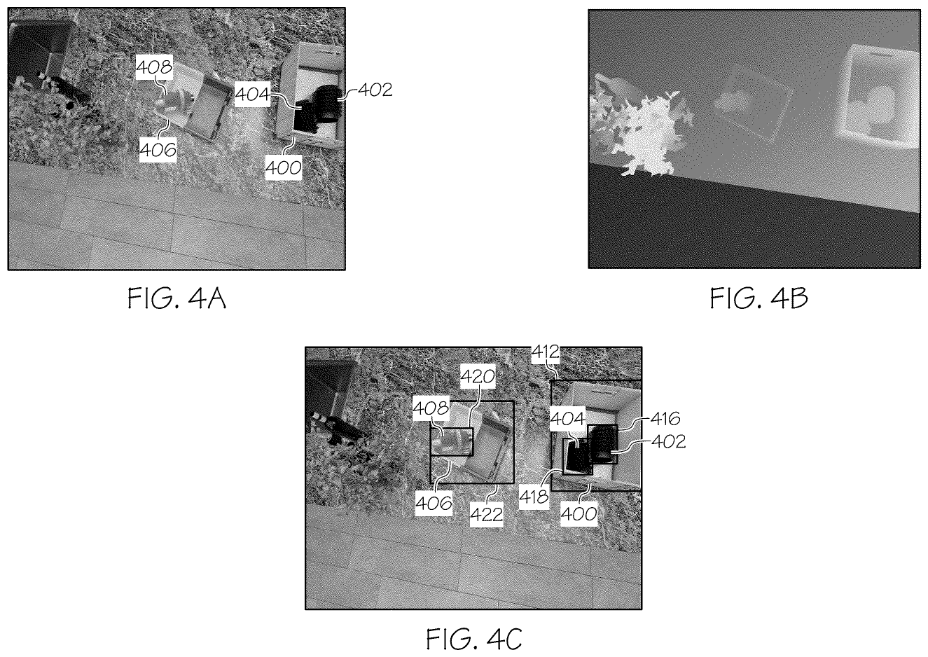

FIG. 4A shows an example synthetic image that may be generated by the image generation module 210. In the example of FIG. 4A, virtual car parts 402 and 404 are placed in virtual container 400, and virtual car part 408 is placed in virtual container 406. FIG. 4B shows an example depth that may be generated by the depth determination module 212 based on the image of FIG. 4A.

Referring back to FIG. 2, the image labeling module 214 may label the synthetic image and the left and right images generated by the image generation module 210, as disclosed herein. In particular, the image labeling module 214 may place bounding boxes around the containers and the car parts in the generated images. The image labeling module 214 may then give a first label (e.g., a “car parts” label) to the bounding boxes around the car parts, and a second label (e.g., a “container” label) to the bounding boxes around the containers. These labels may be used as ground truth values during training of the machine learning model, as disclosed in further detail below. FIG. 4C shows an example image that may be generated by the image labeling module 214 based on the image of FIG. 4A. In particular, the example of FIG. 4C shows the image of FIG. 4A with a bounding box 412 placed around the virtual container 400, a bounding box 416 placed around the virtual car part 402, a bounding box 418 placed around the virtual car part 404, a bounding box 420 placed around the virtual car part 408, and a bounding box 422 placed around the virtual container 406.

Referring back to FIG. 2, the model training module 216 may train the machine learning model maintained by the computing device 100, as disclosed herein. In particular, the model training module 216 may train the machine learning model to receive an input RGB image and a depth map associated with the image, and output a modified image with bounding boxes placed around any containers and car parts within the containers in the image. The bounding boxes may be labeled as either relating to a container or a car part.

In embodiments, the machine learning model maintained by the computing device 100 may be a classifier that can identify and classify containers and car parts in the image. In some examples, the machine learning model maintained by the computing device 100 may be a neural network, which may have any type of neural network architecture. In other examples, the machine learning model may be another type of model.

In embodiments, the model training module 216 may train the machine learning model using supervised learning techniques. In particular, the model training module 216 may receive training data comprising a plurality of training examples. As discussed above, each such training example may comprise the left image generated by the image generation module 210 with bounding boxes and labels generated by the image labeling module 214, and a depth map generated by the depth determination module 212. Accordingly, the model training module 216 may train the machine learning model using supervised learning techniques, and using the labeled bounding boxes as ground truth values. As the machine learning model is trained, parameters associated with the machine learning model may be continually updated until training is complete. Once training is complete, the final learned parameters of the machine learning model may be stored in the database 200.

As discussed above, in the illustrated example, the training data comprises only the left image generated by the image generation module 210 and the depth map generation by the depth determination module 212, associated with each synthetic image generated by the image generation module 210. In other examples, the training data comprises only the right image generated by the image generation module 210 and the depth map. By utilizing only one of the left image or the right image along with depth information as training data, the model training module 216 may complete training the model more quickly since half as many training examples are used compared to using both left and right images as training data. Furthermore, utilizing both the left and right images as training data tends to result in overfitting, which cause the trained model to be less accurate.

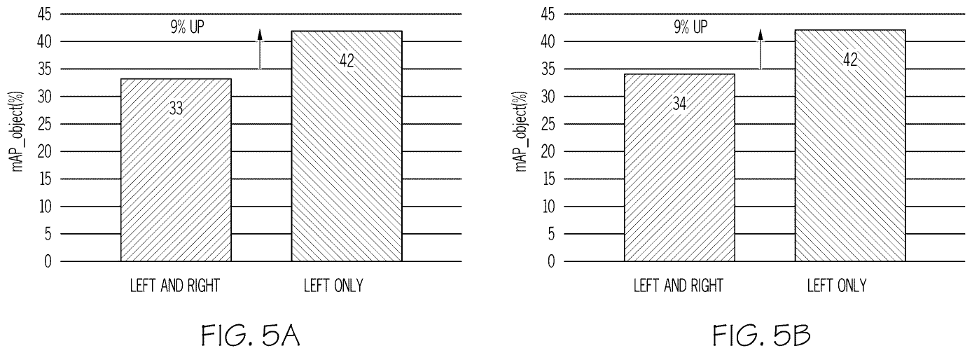

FIGS. 5A and 5B show plots of mean average precision (mAP) for example training that was performed using left and right images versus only left images. In FIG. 5A, the plot on the left shows the result of training the model using a training data set of 9000 images comprising of 4500 left images and 4500 right images. The plot on the right shows the result of training the model using a training data set of 9000 left images. As can be seen in FIG. 5A, the mAP is increased from 33% to 42% by using only left images as opposed to left and right images.

Furthermore, in FIG. 5B. the plot on the left shows the result of training the model using a training data set of 18,000 images comprising of 9000 left images and 4500 right images, whereas the plot on the right shows the result of training the model using a training data set of 9000 left images. As can be seen in FIG. 5B, the mAP is increased from 34% to 42% when training using only left images, even when using half as many images compared to using left and right images.

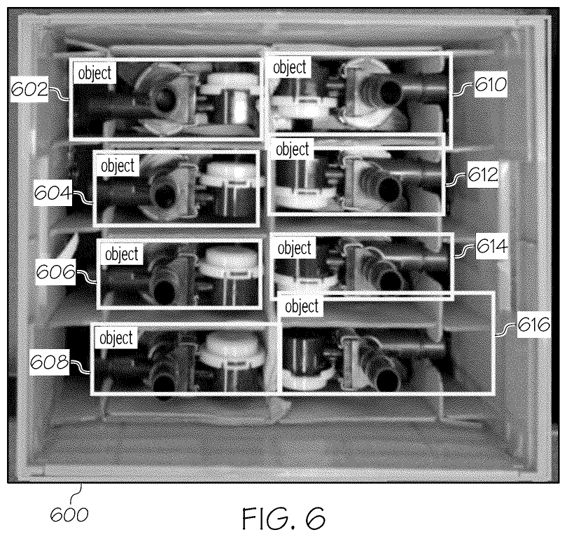

Referring back to FIG. 2, the inference module 218 may perform inference using the trained machine learning model. In particular, the inference module 218 may receive an image containing one or more car parts. The inference module 218 may input the image into the trained machine learning model, and the model may output a modified image showing bounding boxes around the car parts in the image. FIG. 6 shows an example image that may be output by the inference module 218. As shown in the example of FIG. 6, the image includes a bounding box 600 around a container, and bounding boxes 602, 604, 606, 608, 610, 612, 614, and 616 around car parts in the container.

In some examples, a robot may use the computing device 100 to pick car parts from a container. For example, the robot may capture an image of the container (e.g., using a camera), and the inference module 218 may input the image into the trained machine learning model. The trained machine learning model may then output a modified image showing bounding boxes around any identified car parts in the image. The robot may then pick one or more of the identified car parts out of the container. In particular, a robot arm or other mechanism may grab items at locations in the container specified by the bounding boxes in the image output by the machine learning model, and remove the items it grabs. As such, the robot may use the machine learning model maintained by the computing device 100 to identify and pick items from a container.

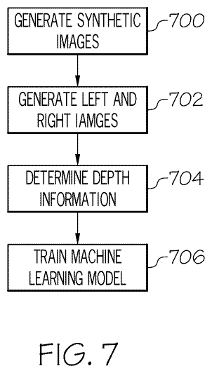

FIG. 7 depicts a flowchart of an example method that may be performed by the computing device 100 to train the machine learning model. At step 700, the image generation module 210 generates synthetic images of virtual car parts in virtual containers at selected positions and having selected orientations. For each synthetic image generated by the image generation module 210, the virtual car parts and virtual containers may be selected by the car part selector module 202. Initial positions and orientations of the virtual car parts in the virtual containers may be determined by the car part placement module 204, and their final positions and orientations may be determined by the physics module 206. The synthetic images may include backgrounds generated by the background generation module 208.

At step 702, the image generation module 210 generates a left image and a right image associated with each generated synthetic image. The image labeling module 214 may also generate and label bounding boxes around the virtual car parts and virtual containers in the generated images.

At step 704, the depth determination module 212 determines depth information (e.g., a depth map) associated with each generated synthetic image. The depth determination module 212 may determine the depth information based on the generated left images and right images.

At step 706, the model training module 216 trains the machine learning model, as discussed above, using only the left images generated by the image generation module 210 and the depth information determined by the depth determination module 212. In some examples, the model training module 216 may train the model using only right images instead of left images. In particular, the model training module 216 may train the machine learning model to identify a car part and a container in a received image using training data including the left images and depth information. In embodiments, the model training module 216 trains the model using supervised learning.

It should now be understood that embodiments described herein are directed to a method and system for training a car parts detector using camera RGB data with depth information. By determining depth information using left and right images of synthetic images, but training a machine learning model using only left images and the depth information, training time can be shortened, and the accuracy of the machine learning model can be improved.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method comprising:
generating synthetic images of virtual car parts in virtual containers at selected positions and having selected orientations;
generating a left image and a right image associated with each synthetic image;
determining depth information for pixels of the synthetic images based on the left image and the right image associated with each synthetic image; and
training a machine learning model to identify a car part and a container in a received image using training data comprising the depth information and only one of the left image or the right image associated with each synthetic image.

2. The method of claim 1, further comprising:
placing first bounding boxes around the virtual car parts in the synthetic images and the virtual car parts in the left image and the right image associated with each synthetic image; and
training the machine learning model to identify car parts using the first bounding boxes.

3. The method of claim 2, further comprising:
placing second bounding boxes around the virtual containers in the synthetic images and the virtual containers in the left image and the right image associated with each synthetic image; and
training the machine learning model using the second bounding boxes.

4. The method of claim 3, further comprising training the machine learning model using supervised learning, wherein the first bounding boxes and the second bounding boxes comprise ground truth values.

5. The method of claim 1, further comprising:
receiving an input range of sizes of virtual car parts to be included in the synthetic images; and
generating the virtual car parts in the synthetic images having sizes within the input range of sizes.

6. The method of claim 1, further comprising selecting the virtual car parts from among a database of potential virtual car parts.

7. The method of claim 6, further comprising randomly selecting the virtual car parts from among the database of potential virtual car parts.

8. The method of claim 1, further comprising randomly selecting the positions and the orientations of the virtual car parts in the synthetic images.

9. The method of claim 1, further comprising determining resting positions and a resting orientations for the virtual car parts in the virtual containers based on the selected positions, the selected orientations, and a physics simulation.

10. The method of claim 1, further comprising:
receiving the received image that includes one or more car parts in the container;
inputting the received image into the trained model; and
identifying the one or more car parts and the container in the received image based on an output of the trained model.

11. A computing device comprising one or more processors configured to:
generate synthetic images of virtual car parts in virtual containers at selected positions and having selected orientations;
generate a left image and a right image associated with each synthetic image;
determine depth information for pixels of the synthetic images based on the left image and the right image associated with each synthetic image; and
train a machine learning model to identify a car part and a container in a received image using training data comprising the depth information and only one of the left image or the right image associated with each synthetic image.

12. The computing device of claim 11, wherein the one or more processors are further configured to:
place first bounding boxes around the virtual car parts in the synthetic images and the virtual car parts in the left image and the right image associated with each synthetic image; and
train the machine learning model to identify car parts using the first bounding boxes.

13. The computing device of claim 12, wherein the one or more processors are further configured to:
place second bounding boxes around the virtual containers in the synthetic images and the virtual containers in the left image and the right image associated with each synthetic image; and
train the machine learning model using the second bounding boxes.

14. The computing device of claim 11, wherein the one or more processors are further configured to:
receive an input range of sizes of virtual car parts to be included in the synthetic images; and
generate the virtual car parts in the synthetic images having sizes within the input range of sizes.

15. The computing device of claim 11, wherein the one or more processors are further configured to select the virtual car parts from among a database of potential virtual car parts.

16. The computing device of claim 15, wherein the one or more processors are further configured to randomly select the virtual car parts from among the database of potential virtual car parts.

17. The computing device of claim 11, wherein the one or more processors are further configured to randomly select the positions and the orientations of the virtual car parts in the synthetic images.

18. The computing device of claim 11, wherein the one or more processors are further configured to determine resting positions and a resting orientations for the virtual car parts in the virtual containers based on the selected positions, the selected orientations, and a physics simulation.

19. The computing device of claim 11, wherein the one or more processors are further configured to:
receive the received image that includes one or more car parts in the container;
input the received image into the trained model; and
identify the one or more car parts and the container in the received image based on an output of the trained model.

20. A non-transitory computer readable storage medium comprising a memory storing a program that, when executed by a processor, cause the processor to:
generate synthetic images of virtual car parts in virtual containers at selected positions and having selected orientations;
generate a left image and a right image associated with each synthetic image;
determine depth information for pixels of the synthetic images based on the left image and the right image associated with each synthetic image; and
train a machine learning model to identify a car part and a container in a received image using training data comprising the depth information and only one of the left image or the right image associated with each synthetic image.
